(19) United States
(12) Patent Application Publication
(10) Pub. No.: US 2025/0298437 A1
(43) Pub. Date: Sep. 25, 2025

(54) CASE HAVING STRUCTURE FOR ASSISTING GRIP OF ELECTRONIC DEVICE

(71) Applicant: SAMSUNG ELECTRONICS CO., LTD., Suwon-si (KR)

(72) Inventors: Kieon LEE, Suwon-si (KR); Saewon KWON, Suwon-si (KR); Kisung KIM, Suwon-si (KR); Keemoon LEE, Suwon-sI (KR); Seungbin IM, Suwon-si (KR)

(21) Appl. No.: 19/230,927

(22) Filed: Jun. 6, 2025

Related U.S. Application Data
(63) Continuation of application No. PCT/KR2023/015935, filed on Oct. 16, 2023.

(30) Foreign Application Priority Data
Dec. 7, 2022 (KR) 10-2022-0169850
Dec. 13, 2022 (KR) 10-2022-0173860

(51) Int. Cl. G06F 1/16

(52) U.S. Cl. CPC G06F 1/163; G06F 1/1629

(57) ABSTRACT

A case for an electronic device may include a frame and a cover plate fastened to the frame. The cover plate may include a first slit and a second slit assembled with the case, wherein the first slit allows one end of a strap to extend therethrough and the second slit allows the other end of the strap to extend therethrough, the other end being opposite to the one end of the strap. The cover plate may include a first fastening region including first protrusions to be fastened to at least a part of a first set of through-holes formed at the one end of the strap and a second fastening region including second protrusions to be fastened to at least a part of a second set of through-holes formed at the other end of the strap and spaced apart from the first fastening region.

### CROSS-REFERENCE TO RELATED APPLICATIONS

This application is a continuation of International Application No. PCT/KR2023/015935 designating the United States, filed on Oct. 16, 2023, in the Korean Intellectual Property Receiving Office and claiming priority to Korean Patent Application Nos. 10-2022-0169850, filed on Dec. 7, 2022, and 10-2022-0173860, filed on Dec. 13, 2022, in the Korean Intellectual Property Office, the disclosures of each of which are incorporated by reference herein in their entireties.

### BACKGROUND

### Field

The disclosure relates to a case including a structure for assisting grip of an electronic device.

### Description of Related Art

An electronic device may be exposed to various environments by being carried by a user. A case may be detachably coupled to the electronic device, thereby protecting the electronic device exposed to the various environments. For example, the case may protect the electronic device from an impact transmitted to the electronic device from the outside of the electronic device. In order to meet a demand of the user, the case may have various functions in addition to a function for protecting the electronic device.

### SUMMARY

According to an example embodiment, a case for an electronic device may comprise: a frame including a first periphery and a second periphery spaced apart from the first periphery, and a cover plate fastened to the first frame; a first surface configured to contact a rear surface of the electronic device stored in the case, a second surface opposite to the first surface; a first slit formed along the first periphery penetrating an end of a strap assembled with respect to the case for assisting grip of the electronic device stored in the case, and a second slit formed along the second periphery penetrating another end opposite to the end of the strap, wherein the cover plate may include a first fastening region on the first surface including first protrusions configured to be fastened to at least a portion of a first set of penetrating holes formed at the end of the strap penetrating the first slit; a second fastening region on the first surface, spaced apart from the first fastening region, including second protrusions configured to be fastened to at least a portion of a second set of penetrating holes formed at the another end of the strap penetrating the second slit.

According to an example embodiment, a case for an electronic device may comprise: a deformable frame including a first periphery and a second periphery spaced apart from the first periphery, and a cover plate fastened to the first frame. According to an embodiment, the cover plate may include a first surface configured to contact a rear surface of the electronic device stored in the case, a second surface opposite to the first surface, and at least one camera hole extending from the first surface to the second surface and configured to expose a camera of the electronic device to the outside, wherein the cover plate may include: a first slit formed along the first periphery penetrating an end of a strap assembled with respect to the case configured to assist a grip of the electronic device stored in the case, and a second slit formed along the second periphery penetrating another end opposite to the end of the strap; a first fastening region on the first surface including first protrusions configured to be fastened to at least a portion of a first set of penetrating holes formed at the end of the strap penetrating the first slit; and a second fastening region on the first surface, spaced apart from the first fastening region, including second protrusions configured to be fastened to at least a portion of a second set of penetrating holes formed at the another end of the strap penetrating the second slit.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1A is an exploded perspective view of an example case for an electronic device according to various embodiments;

FIG. 1B is a diagram illustrating a top plan view of an example case for an electronic device according to various embodiments;

FIG. 2A is a diagram illustrating a rear view of an example case to which a strap is fastened according to various embodiments;

FIGS. 2B, 2C, and 2D are diagrams illustrating plan views of an example case to which a strap is fastened according to various embodiments;

FIG. 2E is a diagram illustrating a plan view of an example case to which a plurality of straps are fastened according to various embodiments;

FIG. 3A is a diagram illustrating a rear view of an example case to which a strap is fastened according to various embodiments;

FIG. 3B is a diagram illustrating a plan view of an example case to which a strap is fastened according to various embodiments;

FIG. 3C is a diagram illustrating a rear view of a cover plate of an example case according to various embodiments;

FIG. 4A is a perspective cross-sectional view illustrating a portion of an example case taken along line A-A′ of FIG. 2B according to various embodiments; and

FIG. 4B is a cross-sectional view of an example case taken along line A-A′ of FIG. 2B according to various embodiments.

### DETAILED DESCRIPTION

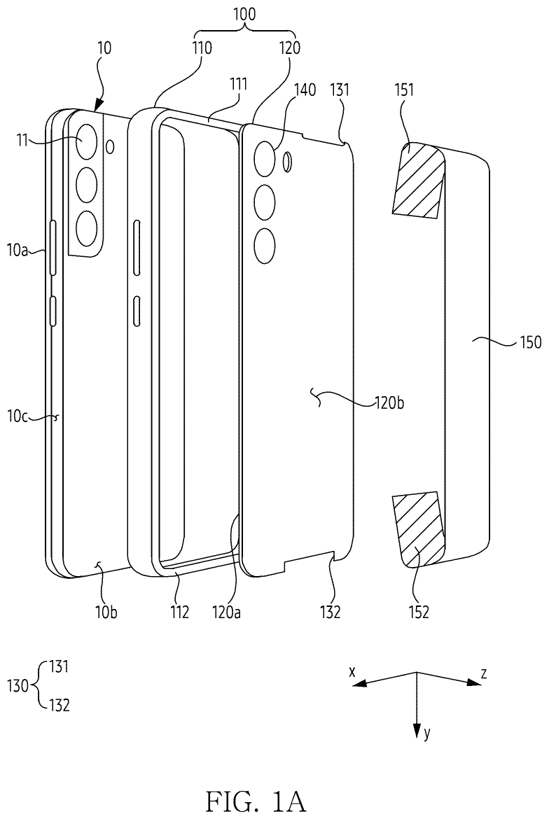

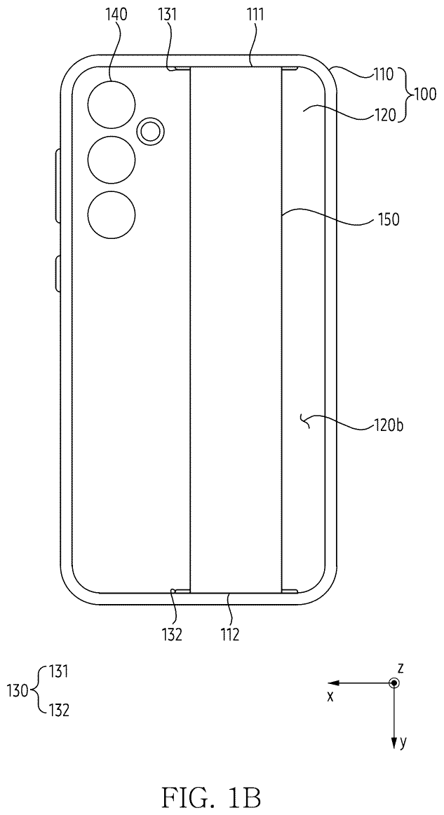

FIG. 1A is an exploded perspective view of an example case for an electronic device according to various embodiments. FIG. 1B is a diagram illustrating a top plan view of an example case for an electronic device according to various embodiments.

Referring to FIGS. 1A and 1B, a case 100 for an electronic device 10 may include a frame 110 and a cover plate 120. According to an embodiment, the case 100 may be detachable with respect to the electronic device 101. The case 100 may protect the electronic device 10 from an external impact in a state of being fastened to the electronic device 10.

According to an embodiment, the frame 110 may surround the electronic device 10 when the case 100 is fastened to the electronic device 10. The frame 110 may include a first periphery 111 and a second periphery 112 spaced apart from the first periphery 111.

For example, the electronic device 10 fastened to the case 100 may include a front surface 10a, a rear surface 10b opposite the front surface 10a, and a side surface 10c surrounding a space between the front surface 10a and the rear surface 10b. On the front surface 10a, a structure (e.g., a display) for visually providing information to the outside (e.g., a user) of the electronic device 10 may be disposed. When the electronic device 10 is fastened to the case 100, the rear surface 10b may be a surface in contact with the cover plate 120 of the case 100. When the electronic device 10 is fastened to the case 100, the frame 110 may cover at least a portion of the side surface 10c of the electronic device 10.

For example, when the electronic device 10 is fastened to the case 100, the frame 110 may be in contact with the side surface 10c of the electronic device 10. The first periphery 111 of the frame 110 may face away from the second periphery 112 of the frame 110. The first periphery 111 may support a portion of the side surface 10c of the electronic device 10. The second periphery 112 may support another portion of the side surface 10c. The frame 110 may include the first periphery 111 supporting the portion of the side surface 10c and the second periphery 112 spaced apart from the first periphery 111 and supporting the other portion of the side surface 10c, thereby reducing the frame 110 from being separated from the electronic device 10 when the electronic device 10 is fastened to the case 100.

According to an embodiment, the frame 110 may be deformable. For example, the frame 110 may be deformable to accommodate the electronic device 10 when the electronic device 10 is fastened to the case 100. For example, the frame 110 may be deformable to accommodate the cover plate 120 fastened to the frame 110.

According to an embodiment, a portion of the frame 110 may be deformable. For example, the first periphery 111 of the frame 110 and the second periphery 112 spaced apart from the first periphery 111 may be deformable. For example, the frame 110 may further include a third periphery 113 connecting the first periphery 111 and the second periphery 112, and a fourth periphery 114 spaced apart from the third periphery 113. The third periphery 113 and the fourth periphery 114 may be deformable. However, the disclosure is not limited thereto. According to an embodiment, the frame 110 may include at least one of rubber and poly carbonate.

According to an embodiment, the cover plate 120 may be fastened to the frame 110. The cover plate 120 may include a first surface 120a contacted with the rear surface 10b of the electronic device 10 stored in the case 100, and a second surface 120b opposite the first surface 120a.

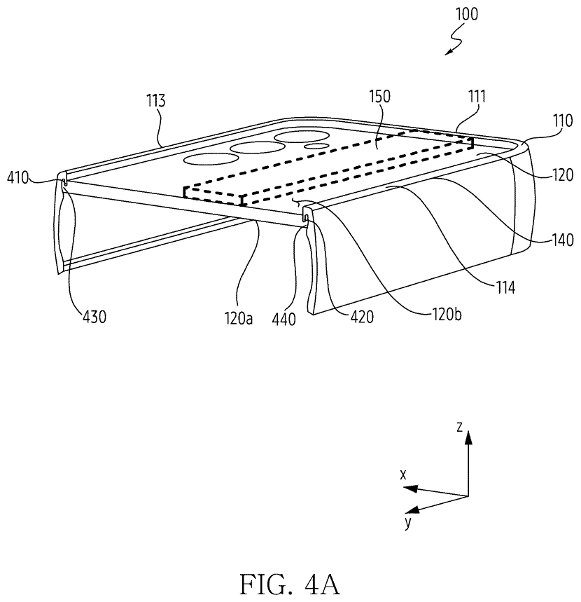

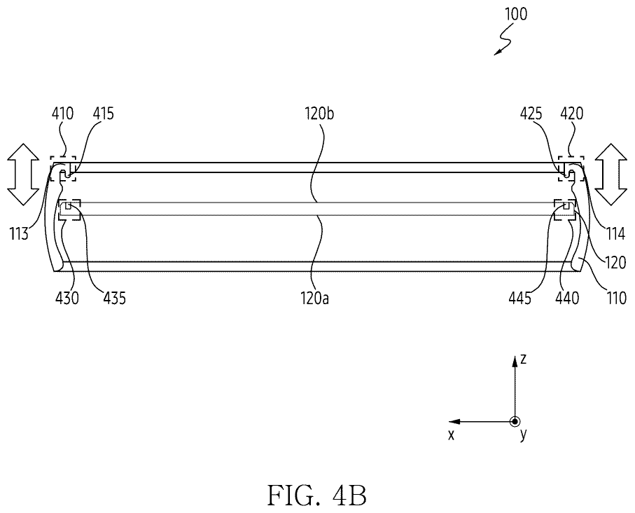

For example, the cover plate 120 may be detachably coupled to the frame 110. For example, the cover plate 120 may be surrounded by the frame 110 when fastened to the frame 110. For example, when the electronic device 10 is stored in the case 100, the cover plate 120 may cover at least a portion of the rear surface 10b of the electronic device 10. The cover plate 120 may reduce the separation from the frame 110 due to an external impact, by being fastened to the frame 110. With regard to the cover plate 120 being fastened to the frame 110, it will be described in greater detail below with reference to FIGS. 4A and 4B.

For example, the first surface 120a of the cover plate 120 fastened to the frame 110 may be a surface facing the rear surface 10b of the electronic device 10 stored in the case 100. For example, the second surface 120b of the cover plate 120 fastened to the frame 110 may be a surface contacted with a part (e.g., a hand) of a body of the user by being exposed to the outside.

According to an embodiment, the cover plate 120 may include at least one slit 130 for penetrating at least a portion of the strap 150 assembled with respect to the case 100 for assisting grip of the electronic device 10 stored in the case 100. The at least one slit 130 may include a first slit 131 formed along the first periphery 111 of the frame 110 for penetrating an end 151 of the strap 150, and a second slit 132 formed along the second periphery 112 of the frame 110 for penetrating another end 152 opposite to the end 151 of the strap 150.

For example, the at least one slit 130 may be a groove formed in a periphery of the cover plate 120 in contact with the frame 110 when the cover plate 120 is fastened to the frame 110. For example, the at least one slit 130 may extend from the first surface 120a of the cover plate 120 to the second surface 120b opposite to the first surface 120a. For example, the at least one slit 130 may be configured to penetrate the at least a portion of the strap 150 assembled with respect to the case 100 from the first surface 120a of the cover plate 120 to the second surface 120b opposite to the first surface 120a. The at least one slit 130 may be configured such that the second surface 120b is in contact with the at least portion of the strap 150, by penetrating the at least portion of the strap 150.

For example, the first slit 131 may face the first periphery 111 of the frame 110. The second slit 132 may face the second periphery 112 of the frame 110. For example, the first slit 131 may be faced away from the second slit 132. For example, the first slit 131 may be penetrated by the end 151 of the strap 150 assembled with respect to the case 100. The second slit 132 may be penetrated by the other end 152 opposite to the end 151 of the strap 150.

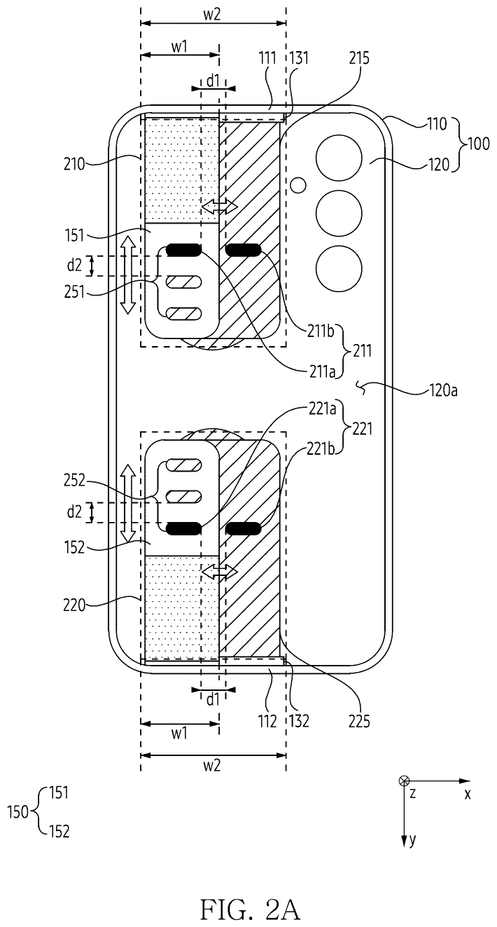

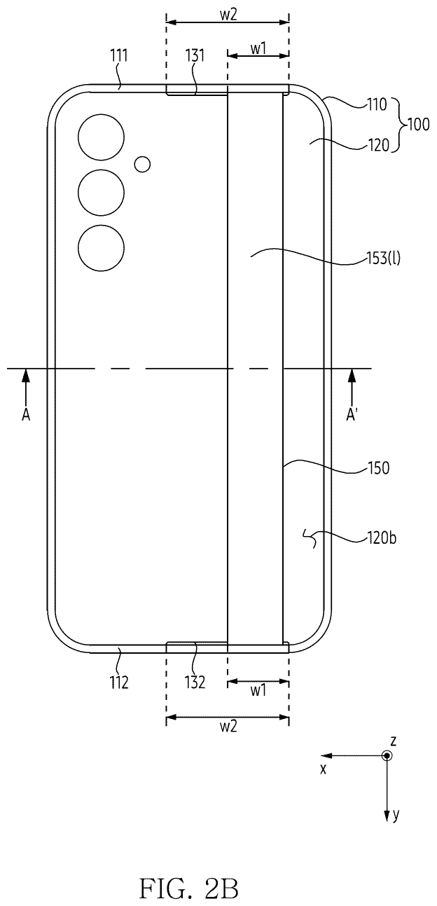

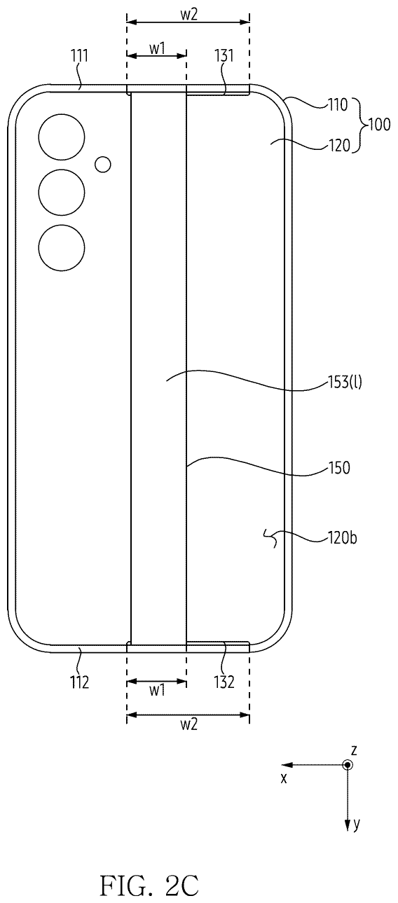

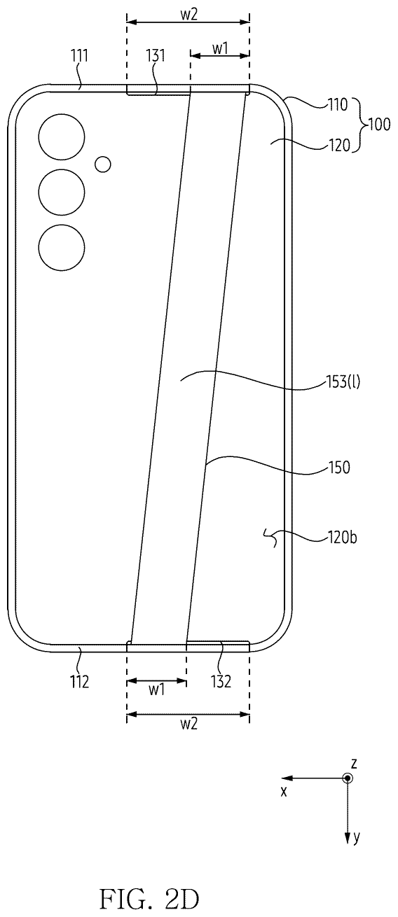

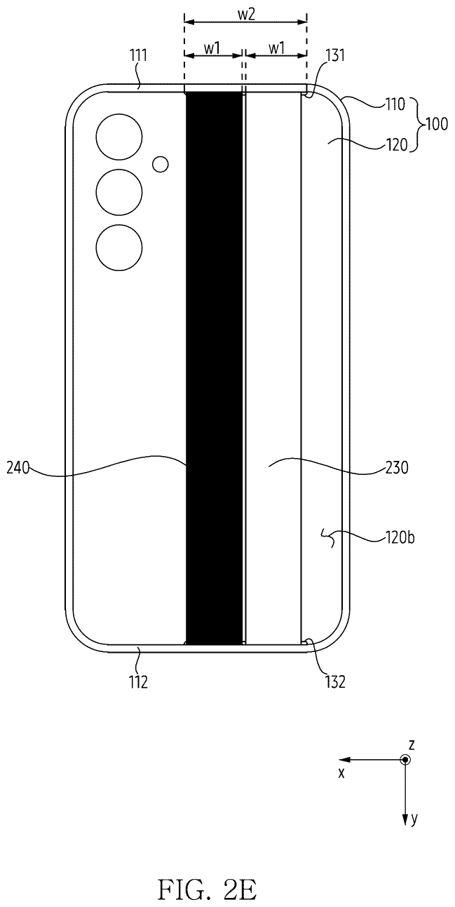

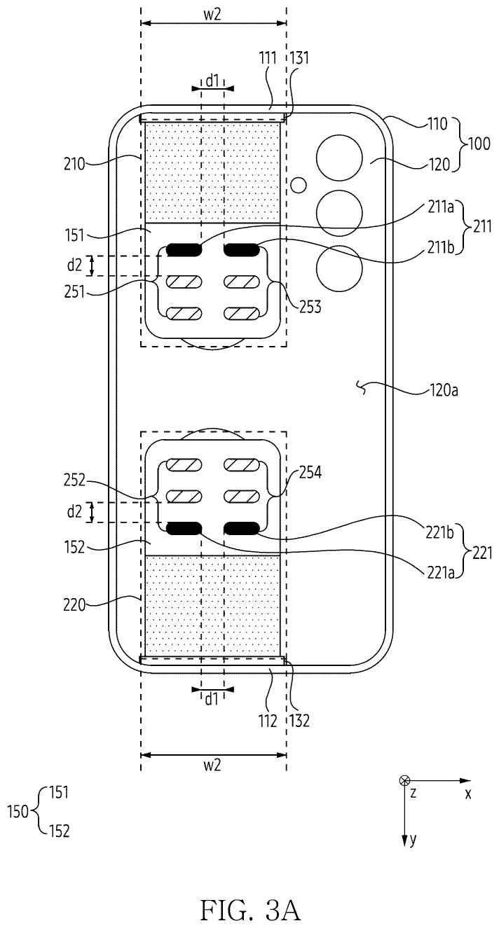

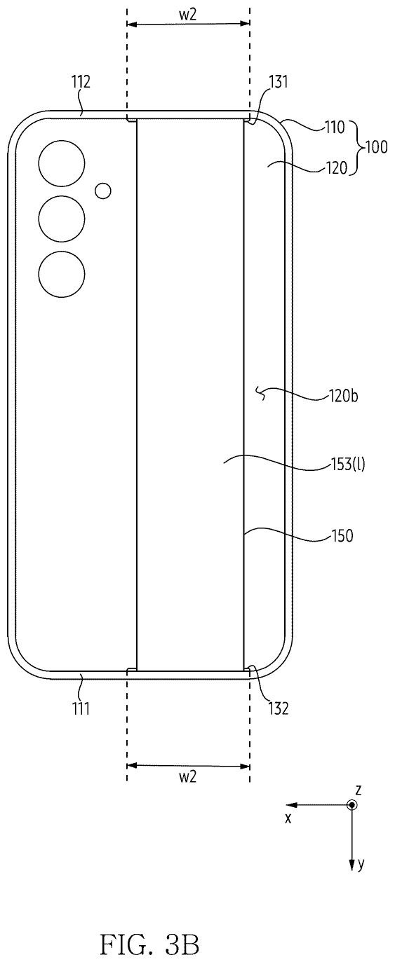

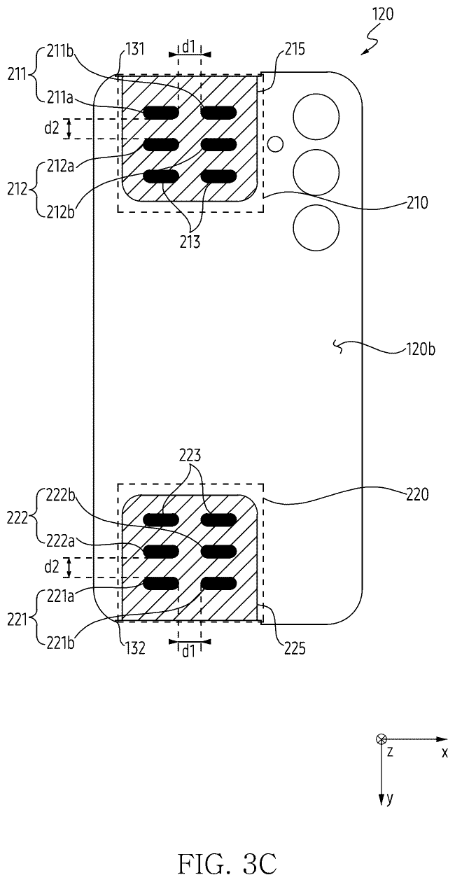

For example, the cover plate 120 may be fastened to the strap 150 assembled with respect to the case 100. The strap 150 may extend from the end 151 of the strap 150 to the other end 152 of the strap 150 across the second surface 120b of the cover plate 120 of the case 100. The first slit 131 may be configured such that the end 151 of the strap 150 is fastened to the first surface 120a opposite to the second surface 120b of the cover plate 120, by being penetrated by the end 151 of the strap 150. The second slit 132 may be configured such that the other end 152 of the strap 150 is fastened to the first surface 120a of the cover plate 120 by being penetrated by the other end 152 of the strap 150. Since the slits 131 and 132 are configured to penetrate the end 151 of the strap 150 and the other end 152 of the strap 150, respectively, the cover plate 120 may reduce the strap 150 assembled with respect to the case 100 from being separated from the case 100. With regard to the strap 150 being assembled with respect to the case 100, it will be described in greater detail below with reference to FIGS. 2A, 2B, 2C, 2D, 2E, 3A, 3B and 3C.

It is described that the cover plate 120 includes the first slit 131 and the second slit 132, but the disclosure is not limited thereto. The at least one slit 130 formed in the cover plate 120 may include a plurality of slits including the first slit 131 and the second slit 132. One of the plurality of slits may penetrate the end 151 of the strap 150 assembled with respect to the case 100. Another slit distinguished from the slit of the plurality of slits may penetrate the other end 152 opposite to the end 151 of the strap 150.

According to an embodiment, the cover plate 120 may further include at least one camera hole 140 for exposing a camera 11 of the electronic device 10 stored in the case 100 to the outside. For example, the electronic device 10 stored in the case 100 may include the camera 11 that is at least partially exposed through the rear surface 10b contacted with the first surface 120a of the cover plate 120 when fastened to the case 100. The cover plate 120 may include the at least one camera hole 140 formed at a position corresponding to the camera 11 when the electronic device 10 is stored in the case 100.

For example, the at least one camera hole 140 may extend from the first surface 120a of the cover plate 120 to the second surface 120b of the cover plate 120. For example, the at least one camera hole 140 may expose at least a portion of the camera 11 to the outside. For example, the at least one camera hole 140 may have substantially the same size as the camera 11 exposed through the at least one camera hole 140. However, the disclosure is not limited thereto. The at least one camera hole 140 may include a plurality of camera holes for exposing each of a plurality of cameras at least partially exposed through the rear surface 10b of the electronic device 10.

According to an embodiment, the cover plate 120 may have a transparent or translucent color. For example, the cover plate 120 may include at least one of glass and polycarbonate. Since the cover plate 120 has a transparent or translucent color, the cover plate 120 may expose a color of the rear surface 10b of the electronic device 10 to the outside.

The case 100 for the electronic device 10 according to an example embodiment may include the frame 110 and the cover plate 120 fastened to the frame 110, thereby protecting the electronic device 10 from an external impact. The cover plate 120 may be configured such that the first surface 120a of the cover plate 120 is fastened to both ends 151 and 152 of the strap 150, by respectively including the slits 131 and 132 configured to penetrate both ends 151 and 152 of the strap 150 assembled with respect to the case 100. The cover plate 120 may assist the user of the electronic device 10 stored in the case 100 to grip the electronic device 10 using the strap 150, by being fastened to the strap 150.

FIG. 2A is a diagram illustrating a rear view of an example case to which a strap is fastened according to various embodiments. FIGS. 2B, 2C, and 2D are diagrams illustrating plan views of an example case to which a strap is fastened according to various embodiments. FIG. 2E is a diagram illustrating a plan view of an example case to which a plurality of straps are fastened according to various embodiments.

Referring to FIGS. 2A, 2B, 2C, and 2D, a case 100 may include a frame 110 and a cover plate 120. The frame 110 may include a first periphery 111 and a second periphery 112. The cover plate 120 may include a first surface 120a, a second surface 120b, a first slit 131, and a second slit 132.

According to an embodiment, the cover plate 120 may include a first fastening region 210 and a second fastening region 220 spaced apart from the first fastening region 210. The first fastening region 210 and the second fastening region 220 may be disposed on the first surface 120a of the cover plate 120. The first fastening region 210 may include first protrusions 211 for fastening to at least a portion of a first set of penetrating holes 251 formed at an end 151 of a strap 150 penetrating the first slit 131. The second fastening region 220 may include second protrusions 221 for fastening to at least a portion of a second set of penetrating holes 252 formed at another end 152 of the strap 150 penetrating the second slit 132.

For example, the first fastening region 220 may be a region contacted with the end 151 of the strap 150 assembled with respect to the case 100. The first fastening region 220 may be a region at least partially covered by the end 151 of the strap 150. For example, the second fastening region 220 may be a region contacted with the other end 152 opposite to the end 151 of the strap 150 assembled with respect to the case 100. The second fastening region 220 may be a region at least partially covered by the other end 152 of the strap 150.

For example, the first region 210 and the second region 220 may be regions separated from a supporting portion 153 of the strap 150 connecting both ends 151 and 152 of the strap 150 assembled with respect to the case 100. The supporting portion 153 may be a portion contacted with a part (e.g., a hand) of a body of a user to assist an electronic device (e.g., the electronic device 10 of FIG. 1A) of the user. The supporting portion 153 may be a region disposed on the second surface 120b of the cover plate 120 of the strap 150 assembled with respect to the case 100. The supporting portion 153 may be a portion of the strap 150 exposed to the outside in a state in which the electronic device 10 is stored in the case 100.

For example, the first fastening region 210 may be disposed along the first slit 131 to be fastened to the end 151 of the strap 150 penetrating the first slit 131. The second fastening region 220 may be disposed along the second slit 132 to be fastened to the other end 152 of the strap 150 penetrating the second slit 132. For example, the first fastening region 210 may provide a space for the end 151 of the strap 150 penetrating the first slit 131 on the first surface 120a adjacent to the first slit 131. The second fastening region 220 may provide a space for the other end 152 of the strap 150 penetrating the second slit 132 on the first surface 120a adjacent to the second slit 132 spaced apart from the first slit 131.

For example, each of the first protrusions 211 may protrude from the first surface 120a toward a rear surface (e.g., the rear surface 10b of FIG. 1A) of the electronic device stored in the case 100, in the first fastening region 210. Each of the second protrusions 221 may protrude from the first surface 120a toward the rear surface 10b of the electronic device 10, in the second fastening region 220 spaced apart from the first fastening region 210.

For example, each of the first protrusions 211 may have a shape corresponding to a shape of each of the first set of penetrating holes 251 for fastening to at least a portion of the first set of penetrating holes 251 formed at the end 151 of the strap 150 penetrating the first slit 131. The first set of penetrating holes 251 may be spaced apart from each other by a second distance d2 in a length direction (e.g., a +y direction and/or a −y direction) of the end 151 in a state to which the end 151 of the strap 150 is fastened within the first fastening region 210. Each of the second protrusions 221 may have a shape corresponding to a shape of each of the second set of penetrating holes 252 for fastening to at least a portion of the second set of penetrating holes 252 formed at the other end 152 of the strap 150 penetrating the second slit 132. The second set of penetrating holes 252 may be spaced apart by the second distance d2 in the length direction (e.g., the +y direction and/or the −y direction) of the other end 152 in a state to which the other end 152 of the strap 150 is fastened within the second fastening region 220. As at least a portion of the first protrusions 211 is fastened to at least a portion of the first set of penetrating holes 251 and at least a portion of the second protrusions 221 is fastened to at least a portion of the second set of penetrating holes 252, the case 100 may be assembled with the strap 150.

For example, each of the first protrusions 211 may be spaced apart from each other at a designated distance within the first fastening region 210. Within the first fastening region 210, each of the first protrusions 211 may be arranged in a direction (e.g., a +x direction and/or a −x direction) parallel to a direction in which the first periphery 111 of the frame 110 adjacent to the first slit 131 extends. Each of the second protrusions 221 may be spaced apart from each other at the designated distance within the second fastening region 220. Within the second fastening region 220, each of the second protrusions 221 may be arranged in a direction (e.g., the +x direction and/or the −x direction) parallel to a direction in which the second periphery 112 of the frame 110 adjacent to the second slit 132 extends. For example, the second protrusions 221 may be faced away from the first protrusions 211 on the first surface 120a. Each of the second protrusions 221 may be arranged in a direction (e.g., the +x direction and/or the −x direction) parallel to a direction in which each of the first protrusions 211 is arranged.

According to an embodiment, each of the first protrusions 211 may be spaced apart by a first distance d1 in a first direction (e.g., the +x direction) within the first fastening region 210. Each of the second protrusions 221 may be spaced apart from each other by the first distance d1 in the first direction within the second fastening region 220.

For example, the first direction may be a width direction of the strap 150 assembled with respect to the case 100. For example, the first direction may be a width direction of the slits 131 and 132 formed at the cover plate 120 for penetrating both ends 151 and 152 of the strap 150, respectively. For example, the first direction may be a direction in which the slits 131 and 132 are respectively parallel to a direction in which the first periphery 111 and the second periphery 112 of the frame 110, which are adjacent to each other, extend.

For example, each of the first protrusions 211 may be arranged in the first direction (e.g., the +x direction) within the first fastening region 210. A distance between the first protrusions 211 may be the first distance d1. For example, each of the second protrusions 221 may be arranged in the first direction (e.g., the +x direction) within the second fastening region 220. A distance between the second protrusions 221 may be the first distance d1.

For example, referring to FIGS. 2A and 2B, the first protrusions 211 may include a first protrusion 211a and a second protrusion 211b. Within the first fastening region 210, the second protrusion 211b may be spaced apart by the first distance d1 in the first direction (e.g., the +x direction) from the first protrusion 211a fastened to a portion of the first set of penetrating holes 251 formed at the end 151 of the strap 150 assembled with respect to the case 100. The second protrusions 221 may include a third protrusion 221a and a fourth protrusion 221b. Within the second fastening region 220, the fourth protrusion 221b may be spaced apart by the first distance d1 in the first direction from the third protrusion 221a fastened to a portion of the second set of penetrating holes 252 formed at the other end 152 of the strap 150 assembled with respect to the case 100. For example, the third protrusion 221a may be faced away from the first protrusion 211a in a second direction (e.g., a +y direction) perpendicular to the first direction. The fourth protrusion 221b may be faced away from the second protrusion 211b spaced apart from the first protrusion 211a by the first distance d1 in the first direction, in the second direction.

According to an embodiment, any one of the first protrusion 211a or the second protrusion 211b may be fastened to at least a portion of the first set of penetrating holes 251 formed at the end 151 of the strap 150 penetrating the first slit 131. Any one of the third protrusion 221a or the fourth protrusion 221b may be fastened to at least a portion of the second set of penetrating holes 252 formed at the other end 152 of the strap 150 penetrating the second slit 132.

For example, referring to FIGS. 2A and 2C, within the first fastening region 210, the second protrusion 211b of the first protrusion 211a and the second protrusion 211b spaced apart from the first protrusion 211a by the first distance d1 in the first direction (e.g., +x direction) may be fastened to the at least a portion of the first set of penetrating holes 251 formed at the end 151 of the strap 150 penetrating the first slit 131. The fourth protrusion 221b within the second fastening region 220 faced away from the second protrusion 211b in the second direction (e.g., the +y direction) perpendicular to the first direction may be fastened to the at least a portion of the second set of penetrating holes 252 formed at the other end 152 of the strap 150 penetrating the second slit 132. Since the fourth protrusion 221b is faced away from the second protrusion 211b in the second direction, the strap 150 assembled with respect to the case 100 may extend from the end 151 to the other end 152 across the second surface 120b of the cover plate 120 in a direction parallel to the y-axis.

For example, referring to FIGS. 2A and 2D, within the first fastening region 210, the second protrusion 211b of the first protrusion 211a and the second protrusion 211b spaced apart from the first protrusion 211a by the first distance d1 in the first direction (e.g., the +x direction) may be fastened to the at least a portion of the first set of penetrating holes 251 formed at the end 151 of the strap 150 penetrating the first slit 131. Within the second fastening region 220, the third protrusion 221a of the third protrusion 221a and the fourth protrusion 221b spaced apart from the third protrusion 221a by the first distance d1 in the first direction may be fastened to the at least a portion of the second set of penetrating holes 252 formed at the other end 152 of the strap 150 penetrating the second slit 132. The supporting portion 153 of the strap 150 extending from the end 151 to the other end 152 across the second surface 120b of the cover plate 120 may be inclined with respect to the y axis on the second surface 120b of the cover plate 120.

It is described that the first protrusions 211 include the first protrusion 211a and the second protrusion 211b, and the second protrusions 221 include the third protrusion 221a and the fourth protrusion 221b, but the disclosure is not limited thereto. Although not illustrated, the first protrusions 211 may further include a plurality of protrusions distinguished from the first protrusion 211a and the second protrusion 211b and spaced apart from each other by the first distance d1 in the first direction (e.g., the +x direction). The second protrusions 221 may further include, within the second fastening region 220, a plurality of protrusions distinguished from the third protrusion 221a and the fourth protrusion 221b and spaced apart from each other by the first distance d1 in the first direction. As the cover plate 120 includes the first protrusions 211 and the second protrusions 221, the cover plate 120 may be configured to change an inclination of the supporting portion 153 of the strap 150 across the second surface 120b with respect to the y axis. The case 100 may provide the user with various user experiences by being configured to change the inclination with respect to the y axis of the supporting portion 153, which is used for the grip of the electronic device 10 of the user, of the strap 150 assembled with respect to the case 100.

Referring back to FIGS. 2A, 2B, 2C, and 2D, at least a portion of the first protrusions 211 may be fastened to at least a portion of the first set of penetrating holes 251 arranged in the second direction (e.g., the +y direction) perpendicular to the first direction (e.g., the +x direction) within the end 151 of the strap 150 assembled with respect to the case 100. At least a portion of the second protrusions 221 may be fastened to at least a portion of the second set of penetrating holes 252 arranged in the second direction within the other end 152 of the strap 150.

For example, the second direction may be a length direction in which the end 151 of the strap 150 assembled with respect to the case 100 extends or a length direction in which the other end 152 of the strap 150 extends. For example, the second direction may be a direction perpendicular to the direction in which the first periphery 111 of the frame 110 extends or a direction perpendicular to the direction in which the second periphery 112 spaced apart from the first periphery 111 of the frame 110 extends.

For example, the first protrusion 211a of the first protrusions 211 may be fastened to a penetrating hole of the first set of penetrating holes 251 arranged in the second direction (e.g., the +y direction) within the end 151 of the strap 150. Since the first protrusion 211a is detachable with respect to each of the first set of penetrating holes 251, the first protrusion 211a may be fastened to another penetrating hole distinguished from the penetrating hole of the first set of penetrating holes 251. As a penetrating hole within the first set of penetrating holes 251 fastened to the first protrusion 211a is changed, a length l of the supporting portion 153 extending from the end 151 of the strap 150 and disposed on the second surface 120b of the cover plate 120 may be changed.

At least a portion of the second protrusions 221 may be fastened to at least a portion of the second set of penetrating holes 252 substantially the same as or similar to the first protrusions 211 fastened to at least a portion of the first set of penetrating holes 251. For example, the third protrusion 221a of the second protrusions 221 may be fastened to a penetrating hole of the second set of penetrating holes 252 arranged in the second direction (e.g., the +y direction) within the other end 152 of the strap 150. Since the third protrusion 221a is detachable with respect to each of the second set of penetrating holes 252, the third protrusion 221a may be fastened to another penetrating hole distinguished from the penetrating hole of the second set of penetrating holes 252. As a penetrating hole within the second set of penetrating holes 252 fastened to the third protrusion 221a is changed, the length l of the supporting portion 153 extending from the other end 152 of the strap 150 to the end 151 of the strap 150 and disposed on the second surface 120b of the cover plate 120 may be changed.

Although it is described that the first protrusion 211a is fastened to the at least a portion of the first set of penetrating holes 251 and the third protrusion 221a is fastened to the at least a portion of the second set of penetrating holes 252, but the disclosure is not limited thereto. A protrusion (e.g., the second protrusion 211b) distinguished from the first protrusion 211a among the first protrusions 211 may be fastened to the at least a portion of the first set of penetrating holes 251 arranged in the second direction (e.g., the +y direction). Another protrusion (e.g., the fourth protrusion 221b) distinguished from the third protrusion 221a among the second protrusions 221 may be fastened to the at least a portion of the second set of penetrating holes 252 arranged in the second direction. As the at least a portion of the first set of penetrating holes 251 fastened to the at least a portion of the first protrusions 211 is changed, and the at least a portion of the second set of penetrating holes 252 fastened to the at least a portion of the second protrusions 221 is changed, the length l of the supporting portion 153 of the strap 150 disposed on the second surface 120b of the cover plate 120 may be changed. The case 100 may adjust the length l of the supporting portion 153 according to a size of a part of the body of the user by being configured to be capable of adjusting the length l of the supporting portion 153, when the user inserts the part (e.g., a finger) of the body of the user between the supporting portion 153 and the second surface 120b for the grip of the electronic device 10.

According to an embodiment, the first slit 131 may have a second width w2 larger than a first width w1 for penetrating the end 151 of the strap 150 having the first width w1. The second slit 132 may have the second width w2 for penetrating the other end 152 of the strap 150 having the first width w1. A size of the first width w1 may be smaller than or equal to a half of a size of the second width w2.

For example, when referring to FIGS. 2C and 2D together, the size of the second width w2 of the first slit 131 penetrated the end 151 of the strap 150 having the first width w1 may be twice the size of the first width w1 of the end 151 of the strap 150. The size of the second width w2 of the second slit 132 penetrated the other end 152 of the strap 150 having the first width w1 may be twice the size of the first width w1 of the other end 152 of the strap 150. As the first width w1 is equal to or less than the half of the size of the second width w2, the slits 131 and 132 having the second width w2, configured to penetrate both ends 151 and 152 of the strap 150, respectively, may be configured to change an inclination with respect to the y axis of the supporting portion 153 of the strap 150 across the second surface 120b. The case 100 may provide the user with various user experiences by being configured to change the inclination with respect to the y axis of the supporting portion 153, which is used for the grip of the electronic device 10 of the user, of the strap 150, assembled with respect to the case 100, having the first width w1.

According to an embodiment, each of the first fastening region 210 and the second fastening region 220 may have the second width w2. The size of the first width w1 of the end 151 of the strap 150 fastened to the first fastening region 210 by penetrating the first slit 131 may be equal to or less than the half of the size of the second width w2. The other end 152 of the strap 150 fastened to the second fastening region 220 by penetrating the second slit 132 may have the first width w1. As the first width w1 is equal to or less than the half of the size of the second width w2, the first fastening region 210 and the second fastening region 220 fastened to both ends 151 and 152 of the strap 150 respectively may be configured to change the inclination with respect to the y axis of the supporting portion 153 of the strap 150 across the second surface 120b. The case 100 may provide the user with various user experiences by being configured to change the inclination with respect to the y axis of the supporting portion 153, which is used for the grip of the electronic device 10 of the user, of the strap 150, assembled with respect to the case 100, having the first width w1.

According to an embodiment, the first fastening region 210 may be contacted with the first slit 131. The second fastening region 220 may be contacted with the second slit 132.

For example, the first fastening region 210 may be disposed adjacent to the first slit 131 on the first surface 120a of the cover plate 120 to be fastened to the end 151 of the strap 150 penetrating the first slit 131. The second fastening region 220 may be spaced apart from the first fastening region 210 and disposed adjacent to the second slit 132 on the first surface 120a of the cover plate 120 to be fastened to the other end 152 of the strap 150 penetrating the second slit 132.

For example, the first fastening region 210 may extend from the first slit 131 on the first surface 120a of the cover plate 120. The second fastening region 220 may extend from the second slit 132 on the first surface 120a of the cover plate 120. As the first fastening region 210 is contacted with the first slit 131, and the second fastening region 220 is contacted with the second slit 132, the case 100 may be configured such that both ends 151 and 152 of the strap 150 assembled with respect to the case 100 are fastened on the first surface 120a of the cover plate 120, respectively, by penetrating the first slit 131 and the second slit 132.

According to an embodiment, the first fastening region 210 may further include a first groove 215 surrounding the first protrusions 211 for accommodating the end 151 of the strap 150 fastened with respect to the case 100. The second fastening region 220 may further include a second groove 225 surrounding the second protrusions 212 for accommodating the other end 152 of the strap 150.

For example, each of the first protrusions 211 may protrude from an inner surface of the first groove 215 toward the rear surface 10b of the electronic device 10 stored in the case 100. Each of the second protrusions 221 may protrude from an inner surface of the second groove 225 toward the rear surface 10b of the electronic device 10. For example, the end 151 of the strap 150 assembled with respect to the case 100 may be contacted with the inner surface of the first groove 215. The other end 152 of the strap 150 may be contacted with the inner surface of the second groove 225. The cover plate 120 may provide a space in which both ends 151 and 152 of the strap 150 may be fastened with respect to the case 100 by including the first groove 215 and the second groove 225.

According to an embodiment, a depth of the first groove 215 may be substantially the same as a length in which each of the first protrusions 211 within the first fastening region 210 protrudes from the inner surface of the first groove 215 toward the rear surface 10b of the electronic device 10 stored in the case 100. Since a thickness of the strap 150, accommodated in the first groove 215, fastened to at least a portion of the first protrusions 211, is substantially the same as the depth of the first groove 215, a portion of the first fastening regions 210 to which the end 151 of the strap 150 is fastened may have a flat shape. The second groove 225 may be configured substantially the same as or similar to the first groove 215 within the second fastening region 220. Since a portion of the first fastening region 210 and a portion of the second fastening region 220 respectively fastened to both ends 151 and 152 of the strap 150 have a flat shape, the cover plate 120 may reduce the strap 150 from being separated from the case 100 or the electronic device 10 stored in the case 100 from being separated by the first protrusions 211, the second protrusions 221, and/or both ends 151 and 152 of the strap 150.

Referring to FIG. 2E, a plurality of straps 230 and 240 may be fastened to the case 100. For example, when referring to FIG. 2A together, the first slit 131 having the second width w2 and the second slit 132 having the second width w2 may penetrate the first strap 230 having the first width w1 which is the half of the second width w2, and the second strap 240 having the first width w1. Although not illustrated, an end of the first strap 230 penetrating the first slit 131 may be fastened to a portion (e.g., the first protrusion 211a) of the first protrusions 211 within the first fastening region 210. An end of the second strap 240 penetrating the first slit 131 may be fastened to another portion (e.g., the second protrusion 211b) distinguished from the portion of the first protrusions 211. Another end of the first strap 230 penetrating the second slit 132 may be fastened to a portion (e.g., the third protrusion 221a) of the second protrusions 221 within the second fastening region 220. Another end of the second strap 240 penetrating the second slit 132 may be fastened to another portion (e.g., the fourth protrusion 221b) distinguished from the portion of the second protrusions 221. The case 100 may provide the user with various user experiences for assisting the grip of the electronic device 10 to the user of the electronic device 10 stored in the case 100 using the plurality of straps 230 and 240, by being configured such that the plurality of straps 230 and 240 are assembled with respect to the case 100.

According to the above-described embodiment, the case 100 may reduce the strap 150 from being separated from the case 100, by including the first fastening region 210 and the second fastening region 220 fastened to both ends 151 and 152 of the strap 150 assembled with respect to the case 100. The case 100 may provide the user of the electronic device 10 stored in the case with various user experiences, by being configured to change the inclination of the supporting portion 153 of the strap 150 disposed on the second surface 120b of the cover plate 120 when the strap 150 is fastened to the cover plate 120. The case 100 may adjust the length l of the supporting portion 153 according to the size of the part of the body of the user, when the user inserts the part (e.g., the finger) of the body of the user between the supporting portion 153 and the second surface 120b for the grip of the electronic device 10, by being configured to change the length l of the supporting portion 153 disposed on the second surface 120b of the strap 150.

FIG. 3A is a diagram illustrating rear view of an example case to which a strap is fastened according to various embodiments. FIG. 3B is a diagram illustrating a plan view of an example case to which a strap is fastened according to various embodiments. FIG. 3C is a diagram illustrating a rear view of a cover plate of an example case according to various embodiments.

Referring to FIGS. 3A, 3B, and 3C, a case 100 may include a frame 110 and a cover plate 120. The frame 110 may include a first periphery 111 and a second periphery 112. The cover plate 120 may include a first surface 120a, a second surface 120b, a first slit 131, a second slit 132, a first fastening region 210, and a second fastening region 220. The first fastening region 210 may include first protrusions 211. The second fastening region 220 may include second protrusions 221.

Hereinafter, a redundant description of the configuration described in FIGS. 2A to 2E may not be repeated here.

Referring to FIGS. 3A and 3B, the first fastening region 210 may may be assembled with respect to the case 100 and have a second width w2 for being fastened to an end 151 of a strap 150 having the second width w2. The second fastening region 220 may have the second width w2 for being fastened to another end 152 of the strap 150 having the second width w2. For example, unlike in FIGS. 2A to 2D, the case 100 may be assembled with the strap 150 having the second width w2 different from a first width (e.g., the first width w1 of FIG. 2A). A size of the second width w2 may be equal to or larger than twice a size of the first width w1. The case 100 may provide a user of the case 100 with various user experiences by being configured to be assembled with the strap 150 having the second width w2 different from the first width w1.

Each of the first protrusions 211 may be spaced apart, within the first fastening region 210, for fastening at least a portion of a first set of penetrating holes 251 formed at the end 141 of the strap 150 and at least a portion of a third set of penetrating holes 253 spaced apart from the first set of penetrating holes 251 by a first distance d1 in a first direction (e.g., a +x direction), by the first distance d1 in the first direction.

Each of the second protrusions 221 may be spaced apart, within the second fastening region 220, for fastening at least a portion of a second set of penetrating holes 252 formed at the other end 152 of the strap 150 and at least a portion of a fourth set of penetrating holes 254 spaced apart from the second set of penetrating holes 252 by the first distance d1 in the first direction, by the first distance d1 in the first direction.

For example, the first protrusions 211 may include a first protrusion 211a and a second protrusion 211b spaced apart from the first protrusion 211a by the first distance d1 in the first direction (e.g., the +x direction). The first protrusion 211a may be fastened to a penetrating hole of the first set of penetrating holes 251 formed at the end 151 of the strap 150. The second protrusion 211b may be fastened to a penetrating hole of the third set of penetrating holes 253, formed at the end 151 of the strap 150, spaced apart from the first set of penetrating holes 251 by the first distance d1 in the first direction.

For example, the second protrusions 221 may include a third protrusion 221a and a fourth protrusion 211b spaced apart from the third protrusion 221a by the first distance d1 in the first direction (e.g., the +x direction). The third protrusion 221a may be fastened to a penetrating hole of the second set of penetrating holes 252 formed at the other end 152 of the strap 150. The fourth protrusion 211b may be fastened to a penetrating hole of the fourth set of penetrating holes 254, formed at the other end 152 of the strap 150, spaced apart from the second set of penetrating holes 252 by the first distance d1 in the first direction. The case 100 may reduce the strap 150 from being separated from the case 100, by including the first protrusions 211 and the second protrusions 221 respectively fastened to both ends 151 and 152 of the strap 150 having the second width w2 that is twice the first width w1.

Referring to FIG. 3C, the first fastening region 210 may further include third protrusions 212 spaced apart from the first protrusions 211 by a second distance d2 in a second direction (e.g., a +y direction) perpendicular to the first direction (e.g., the +x direction). The second fastening region 220 may further include fourth protrusions 222 spaced apart from the second protrusions 221 by the second distance d2 in a third direction (e.g., a −y direction) opposite to the second direction.

For example, when referring to FIGS. 2A to 2D together, when the strap 150 including the first set of penetrating holes 251 and the second set of penetrating holes 252 is fastened to the cover plate 120 by having the first width w1, at least a portion of the first protrusions 211 may be fastened to a portion of the first set of penetrating holes 251 formed in the end 151 of the strap 150. At least a portion of the third protrusions 212 spaced apart from the first protrusions 211 by the second distance d2 in the second direction (e.g., the +y direction) perpendicular to the first direction (e.g., the +x direction) may be fastened to another portion spaced apart from the portion of the first set of penetrating holes 251 fastened to the at least a portion of the first protrusions 211 by the second distance d2 in the second direction. At least a portion of the second protrusions 221 may be fastened to a portion of the second set of penetrating holes 252 formed at the other end 152 of the strap 150. At least a portion of the fourth protrusions 222 spaced apart from the second protrusions 221 by the second distance d2 in the third direction (e.g., the −y direction) opposite the second direction may be fastened to another portion spaced apart from the portion of the second set of penetrating holes 252 fastened to the at least a portion of the second protrusions 221 by the second distance d2 in the third direction.

For example, when the strap 150 including the first set of penetrating holes 251, the second set of penetrating holes 252, the third set of penetrating holes 253, and the fourth set of penetrating holes 254 is fastened to the cover plate 120 by having the second width w2, the first protrusions 211 may be fastened to a portion of the first set of penetrating holes 251 and a portion of the third set of penetrating holes 253, respectively. Each of the third protrusions 212 spaced apart from the first protrusions 211 by the second distance d2 in the second direction (e.g., the +y direction) perpendicular to the first direction (e.g., the +x direction) may be fastened to another portion of the first set of penetrating holes 251 spaced apart from the portion by the second distance d2 in the second direction, and another portion of the third set of penetrating holes 253 spaced apart from the portion by the second distance d2 in the second direction. The second protrusions 221 may be fastened to a portion of the second set of penetrating holes 252 and a portion of the fourth set of penetrating holes 254, respectively. The fourth protrusions 222 spaced apart from the second protrusions 221 by the second distance d2 in the third direction (e.g., the −y direction) opposite the second direction may be fastened to another portion of the second set of penetrating holes 252 spaced apart from the portion by the second distance d2 in the third direction, and another portion of the fourth set of penetrating holes 254 spaced apart from the portion by the second distance d2 in the third direction. The cover plate 120 may reduce the strap 150 from being separated from the case 100 by including a plurality of protrusions fastened to each of the plurality of penetrating holes having a distance (e.g., the second distance d2) corresponding to a distance between the plurality of penetrating holes included in the strap 150.

According to an embodiment, each of the first protrusions 211 may be spaced apart by the first distance d1 in the first direction (e.g., the +x direction). Each of the third protrusions 212 may be spaced apart from each other by the first distance d1 in the first direction.

For example, the third protrusions 212 may include a fifth protrusion 212a and a sixth protrusion 212b spaced apart from the fifth protrusion 212a by the first distance d1 in the first direction (e.g., the +x direction). The fifth protrusion 212a may be spaced apart from the first protrusion 211a of the first protrusions 211 by the second distance d2 in the second direction (e.g., the +y direction) perpendicular to the first direction. The sixth protrusion 212b may be spaced apart from the second protrusion 211b of the first protrusions 211 by the second distance d2 in the second direction. The second protrusion 211b may be spaced apart from the first protrusion 211a by the first distance d1 in the first direction. As the first protrusions 211 are spaced apart by the first distance d1 and the third protrusions 212 are spaced apart by the first distance d1, the first protrusions 211 and the second protrusions 212 may be arranged in the second direction. As the first protrusions 211 and the second protrusions 212 are arranged in the second direction, the cover plate 120 may be fastened to a plurality of penetrating holes (e.g., the first set of penetrating holes 251 of FIG. 2A and/or the third set of penetrating holes 253 of FIG. 3A) formed at the end 151 of the strap 150 and spaced apart by the second distance d2 in the second direction.

Each of the second protrusions 221 may be spaced apart by the first distance d1 in the width direction of the strap 150 within the second fastening region 220. Each of the fourth protrusions 222 may be spaced apart by the first distance d1 in the width direction of the strap 150 within the second fastening region 220.

For example, the fourth protrusions 222 may include a seventh protrusion 222a and an eighth protrusion 222b spaced apart from the seventh protrusion 222a by the first distance d1 in the first direction (e.g., the +x direction). The seventh protrusion 222a may be spaced apart from the third protrusion 221a of the second protrusions 221 by the second distance d2 in the third direction (e.g., the −y direction) perpendicular to the first direction and opposite to the second direction (e.g., the +y direction). The eighth protrusion 222b may be spaced apart from the fourth protrusion 221b of the second protrusions 221 by the second distance d2 in the third direction. The fourth protrusion 221b may be spaced apart from the third protrusion 221a by the first distance d1 in the first direction. As the second protrusions 221 are spaced apart by the first distance d1 and the fourth protrusions 222 are spaced apart by the first distance d1, the second protrusions 221 and the second protrusions 222 may be arranged in the second direction. As the second protrusions 221 and the fourth protrusions 222 are arranged in the third direction, the cover plate 120 may be fastened to a plurality of penetrating holes (e.g., the second set of penetrating holes 252 of FIG. 2A and/or the fourth set of penetrating holes 254 of FIG. 3A) formed at the other end 152 of the strap 150 fastened to the cover plate 120 and spaced apart from each other by the second distance d2 in the third direction.

It is described that the first fastening region 210 includes the first protrusions 211 and the third protrusions 212, and the second fastening region 220 includes the second protrusions 221 and the fourth protrusions 222, but the disclosure is not limited thereto. The first fastening region 210 may include fifth protrusions 213 spaced apart from the third protrusions 212 in the second direction (e.g., the +y direction). The fifth protrusions 213 may be configured to be arranged in the second direction with respect to the first protrusions 211 and the third protrusions 212. The second fastening region 220 may include sixth protrusions 223 spaced apart from the fourth protrusions 222 in the third direction (e.g., the −y direction) opposite to the second direction. However, the disclosure is not limited thereto, and the cover plate 120 may include a plurality of protrusions arranged in the second direction or the third direction for fastening to a plurality of penetrating holes formed at both ends 151 and 152 of the strap 150 fastened to the cover plate 120 and arranged in the second direction or the third direction opposite to the second direction.

According to the above-described embodiment, in the case 100, the first fastening region 210 fastened to both ends 151 and 152 of the strap assembled with respect to the case 100 may reduce the end 151 of the strap 150 from being separated from the cover plate 120 by including a plurality of protrusions (e.g., the first protrusions 211 and/or the third protrusions 212) fastened to the end 151 of the strap 150. The second fastening region 220 may reduce the other end 152 of the strap 150 from being separated from the cover plate 120 by including a plurality of protrusions (e.g., the second protrusions 221 and/or the fourth protrusions 222) fastened to the other end 152 of the strap 150.

FIG. 4A is a partial perspective cross-sectional view illustrating a portion of an example case taken along line A-A′ of FIG. 2B according to various embodiments. FIG. 4B is a cross-sectional view of an example case taken along line A-A′ of FIG. 2B according to various embodiments.

Referring to FIGS. 4A and 4B, a case 100 may include a frame 110 and a cover plate 120. The frame 110 may include a first periphery 111 and a second periphery (e.g., the first periphery 112 of FIG. 1A). The cover plate 120 may include a first surface 120a, a second surface 120b, a first slit 131, and a second slit (e.g., the second slit 132 of FIG. 1A).

According to an embodiment, the frame 110 may further include a third periphery 113 connecting the first periphery 111 and the second periphery 112, a fourth periphery 114 faced away from the third periphery 113, a first fastening structure 410 formed along the third periphery 113, and a second fastening structure 420 formed along the fourth periphery 114. For example, the third periphery 113 and the fourth periphery 114 faced away from the third periphery may extend from the first periphery 111 of the frame 110 to the second periphery 112 spaced apart from the first periphery 111. For example, the third periphery 113 and the fourth periphery 114 may be peripheries extending in a direction parallel to a long axis of the frame 110. For example, the second fastening structure 420 may be faced away from the first fastening structure 410. For example, the first fastening structure 410 and the second fastening structure 420 may be in contact with the second surface 120b of the cover plate 120 fastened to the frame 110.

The cover plate 120 may further include a third fastening structure 430 formed at a periphery of the cover plate 120 extending in a direction parallel to the third periphery 113 and fastened to the first fastening structure 410, and a fourth fastening structure 440 formed at another periphery faced away from the periphery of the cover plate 120 and fastened to the second fastening structure 420. For example, the third fastening structure 430 may extend along the third periphery 113 of the frame 110. The fourth fastening structure 440 may extend along the fourth periphery 114 faced away from the third periphery 113 of the frame 110. As the third fastening structure 430 is fastened to the first fastening structure 410 formed at the third periphery 113 and the fourth fastening structure 440 is fastened to the second fastening structure 420 formed at the fourth periphery 114, the cover plate 120 may be fastened to the frame 110. The cover plate 120 may reduce damage caused by deformation of the frame 110 when the cover plate 120 is fastened to the frame 110 or separated from the frame 110, by being fastened to the third periphery 113 and the fourth periphery among the peripheries 111, 112, 113, and 114 of the frame 110.

According to an embodiment, the first fastening structure 410 may include a first flange portion 415 extending from the third periphery 113 toward the second surface 120b of the cover plate 120 fastened to the frame 110. The second fastening structure 420 may include a second flange portion 425 extending from the fourth periphery 114 toward the second surface 120b of the cover plate 120. The third fastening structure 430 may include a third groove 435 where the first flange portion 415 is inserted. The fourth fastening structure 440 may include a fourth groove 445 where the second flange portion 425 is inserted.

For example, the first flange portion 415 may face a periphery of the cover plate 120 on which the third fastening structure 430 is formed. The second flange portion 425 may face another periphery of the cover plate 120 on which the fourth fastening structure 440 is formed. For example, the third groove 435 fastened to the first flange portion 415 may have a shape corresponding to the first flange portion 415. The fourth groove 445 fastened to the second flange portion 425 may have a shape corresponding to the second flange portion 425. In order to be fastened to the first flange portion 415, the third groove 435 may extend along a periphery of the cover plate 120 facing the third periphery 113 on which the first flange portion 415 is formed. In order to be fastened to the second flange portion 425, the fourth groove 445 may extend along another periphery of the cover plate 120 facing the fourth periphery 114 on which the second flange portion 425 is formed. As the frame 110 includes the first flange portion 415 and the second flange portion 425, and the cover plate 120 includes the third groove 435 fastened to the first flange portion 415 and the fourth groove 445 fastened to the second flange portion 425, the case 100 may reduce the cover plate 120 from being separated from the frame 110.

According to the above embodiment, the case 100 may reduce damage caused by deformation of the frame 110 when the cover plate 120 is fastened or separated from the frame 110 and reduce the cover plate 120 from being separated from the frame 110 when the cover plate 120 is fastened to the frame 110, by including the first fastening structure 410, the second fastening structure 420 faced away from the first fastening structure 410, the third fastening structure 430 fastened to the first fastening structure 410, and the fourth fastening structure 440, faced away from the third fastening structure 430 and fastened to the second fastening structure 420.

According to the above-described example embodiment, a case (e.g., the case 100 of FIG. 1A) for an electronic device (e.g., the electronic device 10 of FIG. 1A) may comprise a frame (e.g., the frame 110 of FIG. 1A) including a first periphery (e.g., the first periphery 111 of FIG. 1A) and a second periphery (e.g., the second edge 112 of FIG. 1A) spaced apart from the first periphery, and a cover plate (e.g., the cover plate 120 of FIG. 1A) fastened to the first frame. According to an embodiment, the cover plate may include a first surface (e.g., the first surface 120a of FIG. 1A) contacted with a rear surface (e.g., the rear surface 10b of FIG. 1A) of the electronic device stored in the case, a second surface (e.g., the second surface 120b of FIG. 1A) opposite to the first surface. According to an embodiment, the cover plate may include a first slit (e.g., the first slit 130 of FIG. 1A) formed along the first periphery for penetrating an end (e.g., the end 151 in FIG. 1A) of a strap (e.g., the strap 150 of FIG. 1A) assembled with respect to the case for assisting grip of the electronic device stored in the case, and a second slit (e.g., the second slit 132 of FIG. 1A) formed along the second periphery for penetrating another end (e.g., the other end 152 of FIG. 1A) opposite to the end of the strap. According to an embodiment, the cover plate may include a first fastening region (e.g., the first fastening region 210 of FIG. 2A) on the first surface including first protrusions (e.g., the first protrusions 211 of FIG. 2A) for fastening to at least a portion of a first set of penetrating holes (e.g., the first set of penetrating holes 251 of FIG. 2A) formed at the end of the strap penetrating the first slit. According to an embodiment, the cover plate may include a second fastening region (e.g., the second fastening region 220 of FIG. 2A) on the first surface, spaced apart from the first fastening region, including second protrusions (e.g., the second protrusions 221 of FIG. 2A) for fastening to at least a portion of a second set of penetrating holes (e.g., the second set of penetrating holes 252 of FIG. 2A) formed at the another end of the strap penetrating the second slit. According to the above-mentioned embodiment, the case may be configured to fasten the strap on the first surface of the cover plate by including the first slit and the second slit. The cover plate may reduce the strap assembled with respect to the case from being separated from the case by including the first fastening region and the second fastening region. An example embodiment may have various effects including the above-mentioned effects.

According to an example embodiment, each of the first protrusions may be spaced apart by a first distance in a first direction (e.g., the first distance d1 of FIG. 2A) within the first fastening region, and each of the second protrusions may be spaced apart by the first distance in the first direction within the second fastening region. According to the above-mentioned embodiment, each of the first protrusions may be configured to change a position in which the end of the strap is fastened within the first fastening region by being spaced apart by the first distance in the first direction. Each of the second protrusions may be configured to change a position in which the other end of the strap is fastened within the second fastening region, by being spaced apart from each other by the first distance in the first direction. An example embodiment may have various effects including the above-mentioned effects.

According to an example embodiment, the first fastening region may further include third protrusions (e.g., the third protrusions 212 of FIG. 3C) spaced apart from the first protrusions by a second distance (e.g., the second distance d2 of FIG. 2A) in a second direction perpendicular to the first direction, and the second fastening region may further include fourth protrusions (e.g., the fourth protrusions 222 of FIG. 3C) spaced apart from the second protrusions by the second distance in a third direction opposite to the second direction. According to the above-mentioned embodiment, the first fastening region may reduce the end of the strap fastened to the first fastening region from being separated from the case by including the third protrusions. The second fastening region may reduce the other end of the strap fastened to the second fastening region from being separated from the case by including the fourth protrusions. An example embodiment may have various effects including the above-mentioned effects.

According to an example embodiment, each of the third protrusions may be spaced apart by the first distance in the first direction within the first fastening region, and each of the fourth protrusions may be spaced apart by the first distance in the first direction within the second fastening region. According to the above-mentioned embodiment, each of the third protrusions may be configured to change a position in which the end of the strap is fastened within the first fastening region by being spaced apart by the first distance in the first direction. Each of the fourth protrusions may be configured to change a position in which the other end of the strap is fastened within the second fastening region by being spaced apart from each other by the first distance in the first direction. An example embodiment may have various effects including the above-mentioned effects.

According to an example embodiment, the first slit may have a second width (e.g., the second width w2 of FIG. 2A) larger than a first width (e.g., the first width w1 of FIG. 2A) for penetrating the end of the strap having the first width, and the second slit may have the second width for penetrating the another end of the strap having the first width. According to an embodiment, a size of the first width may be smaller than or equal to a half of a size of the second width. According to the above-mentioned embodiment, the case may be configured such that a plurality of straps having the first width are assembled with respect to the case by including the first slit and the second slit having the second width. An example embodiment may have various effects including the above-mentioned effects.

According to an example embodiment, each of the first fastening region and the second fastening region may have the second width. According to an example embodiment, the case may be configured such that a plurality of straps having the first width may be assembled with respect to the case, by including the first fastening region and the second fastening region having the second width. An example embodiment may have various effects including the above-mentioned effects.

According to an example embodiment, the first fastening region may be contacted with the first slit and the second fastening region may be contacted with the second slit. According to the above-mentioned embodiment, the first fastening region may be fastened to the end of the strap penetrating the first slit by being contacted with the first slit. The second fastening region may be fastened to the other end of the strap penetrating the second slit by being contacted with the second slit. An example embodiment may have various effects including the above-mentioned effects.

According to an example embodiment, the first fastening region may be assembled to the case and have a second width for fastening to the end of the strap having the second width. The second fastening region may have the second width for fastening to the another end of the strap having the second width. Each of the first protrusions may be spaced apart, within the first fastening region, for fastening at least a portion of a first set of penetrating holes formed at the end of the strap and at least a portion of a third set of penetrating holes (e.g., the third set of penetrating holes 253 of FIG. 3A) spaced apart from the first set of penetrating holes by a first distance in a first direction, by the first distance in the first direction. Each of the second protrusions may be spaced apart, within the second fastening region, for fastening at least a portion of a second set of penetrating holes formed at the another end of the strap and at least a portion of a fourth set of penetrating holes (e.g., the fourth set of penetrating holes 254 of FIG. 3A) spaced apart from the second set of penetrating holes by the first distance in the first direction, by the first distance in the first direction. According to an example embodiment, the first fastening region may reduce the one end of the strap from being separated from the case by including the first protrusions spaced apart from each other by the first distance. The second fastening region may reduce the other end of the strap from being separated from the case by including the second protrusions spaced apart from each other by the second distance. An example embodiment may have various effects including the above-mentioned effects.

According to an example embodiment, the first fastening region may further include third protrusions, spaced apart from the first protrusions by a second distance in a second direction perpendicular the first direction, spaced apart by the first direction in the first direction. The second fastening region may further include fourth protrusions, spaced apart from the second protrusions by the second distance in a third direction opposite to the second direction, spaced apart by the first direction in the first direction. According to an example embodiment, the first fastening region may reduce the end of the strap fastened to the first fastening region from being separated from the case by including the third protrusions. The second fastening region may reduce the other end of the strap fastened to the second fastening region from being separated from the case by including the fourth protrusions. An example embodiment may have various effects including the above-mentioned effects.

According to an example embodiment, the first fastening region may further include a first groove (e.g., the first groove 215 of FIG. 2A) surrounding the first protrusions for accommodating the end of the strap fastened with respect to the case. The second fastening region may further include a second groove (e.g., the second groove 225 of FIG. 2A) surrounding the second protrusions for accommodating the another end of the strap. According to an example embodiment, the first fastening region may provide a space for the end of the strap fastened to the first fastening region by including the first groove. The second fastening region may provide a space for the other end of the strap fastened to the second fastening region by including the second groove. An example embodiment may have various effects including the above-mentioned effects.

According to an example embodiment, the frame may further include a third periphery (the third periphery 113 of FIG. 4A) connecting the first periphery and the second periphery, and a fourth periphery (e.g., the fourth periphery 114 of FIG. 4A) faced away from the third periphery, a first fastening structure (e.g., the first fastening structure 410 of FIG. 4A) formed along the third periphery, and a second fastening structure (e.g., the second fastening structure 420 of FIG. 4A) formed along the fourth periphery. The cover plate may further include a third fastening structure (e.g., the third fastening structure 430 of FIG. 4A), fastened to the first fastening structure, formed at a periphery extended in a direction parallel to the third periphery, and a fourth fastening structure (e.g., the fourth fastening structure 440 of FIG. 4A), fastened to the second fastening structure, formed at another periphery faced away from the periphery of the cover plate. According to an example embodiment, the case may reduce deformation of the frame when the cover plate is fastened to or separated from the frame, by including the first fastening structure and the second fastening structure facing each other, the third fastening structure fastened to the first fastening structure, and the fourth fastening structure fastened to the second fastening structure. An example embodiment may have various effects including the above-mentioned effects.

According to an example embodiment, the first fastening structure may include a first flange portion (e.g., the first flange portion 415 of FIG. 4B) extended from the third periphery towards the second surface of the cover plate fastened to the frame, and the second fastening structure may include a second flange portion (e.g., the second flange portion 425 of FIG. 4B) extended from the fourth periphery towards the second surface of the cover plate. The third fastening structure may include a third groove (e.g., the third groove 435 of FIG. 4B) where the first flange portion is inserted, and the fourth fastening structure may include a fourth groove (e.g., the fourth groove 445 of FIG. 4B) where the second flange portion is inserted. According to the above-mentioned embodiment, the case may reduce deformation of the frame when the cover plate is fastened to or separated from the frame, by including the first flange portion and the second flange portion facing each other, the third groove where the first flange portion is inserted, and the fourth groove where the second flange portion is inserted. An example embodiment may have various effects including the above-mentioned effects.

According to an example embodiment, the cover plate may further include at least one camera hole (e.g., the at least one camera hole 140 of FIG. 1A) for exposing a camera (e.g., the camera 11 in FIG. 1A) of the electronic device stored in the case to the outside. According to the above-mentioned embodiment, the case may expose the camera of the electronic device to the outside by including the at least one camera hole. An example embodiment may have various effects including the above-mentioned effects.

According to an example embodiment, the frame may be deformable. According to the above-mentioned embodiment, the frame may be configured such that the cover plate may be easily fastened to the frame, by being deformable. The frame may be configured to be easily separated from the frame in a state in which the cover plate is fastened to the frame, by being deformable. An example embodiment may have various effects including the above-mentioned effects.

According to an example embodiment, the cover plate may have a transparent or translucent color. According to the above-mentioned embodiment, the cover plate may expose a color of the rear surface of the electronic device stored in the case to the outside, by having a transparent or translucent color. The case may provide a user of the electronic device with various user experiences by exposing the color of the rear surface of the electronic device to the outside. An example embodiment may have various effects including the above-mentioned effects.

According to an example embodiment, a case for an electronic device may comprise a deformable frame including a first periphery and a second periphery spaced apart from the first periphery, and a cover plate fastened to the first frame. According to an example embodiment, the cover plate may include a first surface contacted with a rear surface of the electronic device stored in the case, a second surface opposite to the first surface, and at least one camera hole that extends from the first surface to the second surface and is for exposing a camera of the electronic device to the outside. According to an example embodiment, the cover plate may include a first slit formed along the first periphery for penetrating an end of a strap assembled with respect to the case for assisting grip of the electronic device stored in the case, and a second slit formed along the second periphery for penetrating another end opposite to the end of the strap. According to an example embodiment, the cover plate may include a first fastening region on the first surface including first protrusions for fastening to at least a portion of a first set of penetrating holes formed at the end of the strap penetrating the first slit. According to an example embodiment, the cover plate may include a second fastening region on the first surface, spaced apart from the first fastening region, including second protrusions for fastening to at least a portion of a second set of penetrating holes formed at the another end of the strap penetrating the second slit. According to an example embodiment, the case may be configured to fasten the strap on the first surface of the cover plate by including the first slit and the second slit. The frame may be configured such that the cover plate to be easily fastened to the frame by being deformable. The frame may be configured to be easily separated from the frame in a state in which the cover plate is fastened to the frame by being deformable. The cover plate may expose the camera of the electronic device to the outside by including the at least one camera hole. The cover plate may reduce the strap assembled with respect to the case from being separated from the case by including the first fastening region and the second fastening region. An example embodiment may have various effects including the above-mentioned effects.

According to an example embodiment, the first fastening region may further include a first groove surrounding the first protrusions for accommodating the end of the strap fastened with respect to the case, and the second fastening region may further include a second groove surrounding the second protrusions for accommodating the another end of the strap. According to an example embodiment, the first fastening region may provide a space for the end of the strap fastened to the first fastening region by including the first groove. The second fastening region may provide a space for the other end of the strap fastened to the second fastening region by including the second groove. An example embodiment may have various effects including the above-mentioned effects.

According to an example embodiment, each of the first protrusions may be spaced apart by a first distance in a first direction within the first fastening region, and each of the second protrusions may be spaced apart by the first distance in the first direction within the second fastening region. According to an embodiment, the first fastening region may further include third protrusions spaced apart from the first protrusions by a second distance in a second direction perpendicular to the first direction, and the second fastening region may further include fourth protrusions spaced apart from the second protrusions by the second distance in a third direction opposite to the second direction. According to the above-mentioned embodiment, the first fastening region may reduce the end of the strap fastened to the first fastening region from being separated from the case, by including the third protrusions. The second fastening region may reduce the other end of the strap fastened to the second fastening region from being separated from the case, by including the fourth protrusions. An example embodiment may have various effects including the above-mentioned effects.

According to an example embodiment, the frame may further include a third periphery connecting the first periphery and the second periphery, and a fourth periphery faced away from the third periphery, a first fastening structure formed along the third periphery, and a second fastening structure formed along the fourth periphery. The cover plate may further include a third fastening structure, fastened to the first fastening structure, formed at a periphery extended in a direction parallel to the third periphery, and a fourth fastening structure, fastened to the second fastening structure, formed at another periphery faced away from the periphery of the cover plate. According to an example embodiment, the case may reduce deformation of the frame when the cover plate is fastened to or separated from the frame, by including the first fastening structure and the second fastening structure facing each other, the third fastening structure fastened to the first fastening structure, and the fourth fastening structure fastened to the second fastening structure. An example embodiment may have various effects including the above-mentioned effects.

According to an example embodiment, the first fastening structure may include a first flange portion extended from the third periphery towards the second surface of the cover plate fastened to the frame, and the second fastening structure may include a second flange portion extended from the fourth periphery towards the second surface of the cover plate. The third fastening structure may include a third groove where the first flange portion is inserted, and the fourth fastening structure may include a fourth groove where the second flange portion is inserted. According to an example embodiment, the case may reduce deformation of the frame when the cover plate is fastened to or separated from the frame, by including the first flange portion and the second flange portion facing each other, the third groove where the first flange portion is inserted, and the fourth groove where the second flange portion is inserted. An example embodiment may have various effects including the above-mentioned effects.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A case for an electronic device, comprising:
a frame including a first periphery and a second periphery spaced apart from the first periphery; and
a cover plate fastened to the frame,
wherein the cover plate includes:
a first surface configured to contact a rear surface of the electronic device stored in the case;
a second surface opposite to the first surface;
a first slit formed along the first periphery and configured to penetrate an end of a strap assembled with respect to the case and configured to assist a grip of the electronic device stored in the case;
a second slit formed along the second periphery and configured to penetrate another end opposite to the end of the strap;
a first fastening region on the first surface including first protrusions configured to fasten to at least a portion of a first set of penetrating holes formed at the end of the strap penetrating the first slit; and
a second fastening region on the first surface, spaced apart from the first fastening region, including second protrusions configured to fasten to at least a portion of a second set of penetrating holes formed at the another end of the strap penetrating the second slit.

2. The case of claim 1,
wherein each of the first protrusions is spaced apart by a first distance in a first direction within the first fastening region, and
wherein each of the second protrusions is spaced apart by the first distance in the first direction within the second fastening region.

3. The case of claim 2,
wherein the first fastening region further includes third protrusions spaced apart from the first protrusions by a second distance in a second direction perpendicular to the first direction, and
wherein the second fastening region further includes fourth protrusions spaced apart from the second protrusions by the second distance in a third direction opposite to the second direction.

4. The case of claim 3,
wherein each of the third protrusions is spaced apart by the first distance in the first direction within the first fastening region, and
wherein each of the fourth protrusions is spaced apart by the first distance in the first direction within the second fastening region.

5. The case of claim 1,
wherein the first slit has a second width larger than a first width for penetrating the end of the strap having the first width,
wherein the second slit has the second width for penetrating the another end of the strap having the first width, and
wherein a size of the first width is smaller than or equal to a half of a size of the second width.

6. The case of claim 1,
wherein each of the first fastening region and the second fastening region has the second width.

7. The case of claim 1,
wherein the first fastening region contacts the first slit, and
wherein the second fastening region contacts the second slit.

8. The case of claim 1,
wherein the first fastening region is configured to be assembled to the case and has a second width for fastening to the end of the strap having the second width,
wherein the second fastening region has the second width for fastening to the another end of the strap having the second width,
wherein each of the first protrusions is spaced apart, within the first fastening region, for fastening at least a portion of a first set of penetrating holes formed at the end of the strap and at least a portion of a third set of penetrating holes spaced apart from the first set of penetrating holes by a first distance in a first direction, by the first distance in the first direction,
wherein each of the second protrusions is spaced apart, within the second fastening region, for fastening at least a portion of a second set of penetrating holes formed at the another end of the strap and at least a portion of a fourth set of penetrating holes spaced apart from the second set of penetrating holes by the first distance in the first direction, by the first distance in the first direction,

9. The case of claim 1,
wherein the first fastening region further includes third protrusions, spaced apart from the first protrusions by a second distance in a second direction perpendicular the first direction, spaced apart by the first direction in the first direction, and
wherein the second fastening region further includes fourth protrusions, spaced apart from the second protrusions by the second distance in a third direction opposite to the second direction, spaced apart by the first direction in the first direction.

10. The case of claim 1,
wherein the first fastening region further includes a first groove surrounding the first protrusions to accommodate the end of the strap fastened with respect to the case, and
wherein the second fastening region further includes a second groove surrounding the second protrusions to accommodate the another end of the strap.

11. The case of claim 1,
wherein the frame further includes a third periphery connecting the first periphery and the second periphery, a fourth periphery facing away from the third periphery, and a first fastening structure comprising at least one groove formed along the third periphery, and a second fastening structure comprising at least one groove formed along the fourth periphery,
wherein the cover plate further includes a third fastening structure comprising at least one groove, fastened to the first fastening structure, formed at a periphery extending in a direction parallel to the third periphery; and a fourth fastening structure comprising at least one groove, fastened to the second fastening structure, formed at another periphery faced away from the periphery of the cover plate.

12. The case of claim 11,
wherein the first fastening structure includes a first flange extending from the third periphery towards the second surface of the cover plate fastened to the frame,
wherein the second fastening structure includes a second flange extending from the fourth periphery towards the second surface of the cover plate,
wherein the third fastening structure includes a third groove where the first flange portion is inserted, and
wherein the fourth fastening structure includes a fourth groove where the second flange portion is inserted.

13. The case of claim 1,
wherein the cover plate further includes at least one camera hole configured to expose a camera of the electronic device stored in the case to the outside.

14. The case of claim 1,
wherein the frame is deformable.

15. The case of claim 1,
wherein the cover plate has a transparent or translucent color.

16. A case for an electronic device, comprising:
a frame including a first periphery and a second periphery spaced apart from the first periphery; and
a cover plate fastened to the frame,
wherein the cover plate includes:
a first surface configured to contact a rear surface of the electronic device stored in the case;
a second surface opposite to the first surface;
at least one camera hole configured to expose a camera of the electronic device to outside extending from the first surface to the second surface;
a first slit formed along the first periphery configured to penetrate an end of a strap configured to be assembled with respect to the case to assist grip of the electronic device stored in the case;
a second slit formed along the second periphery configured to penetrate another end opposite to the end of the strap;
a first fastening region on the first surface including first protrusions configured to fasten to at least a portion of a first set of penetrating holes formed at the end of the strap penetrating the first slit; and
a second fastening region on the first surface, spaced apart from the first fastening region, including second protrusions configured to fasten to at least a portion of a second set of penetrating holes formed at the another end of the strap penetrating the second slit.

17. The case of claim 16,
wherein the first fastening region further includes a first groove surrounding the first protrusions to accommodate the end of the strap fastened with respect to the case, and
wherein the second fastening region further includes a second groove surrounding the second protrusions to accommodate the another end of the strap.

18. The case of claim 16,
wherein each of the first protrusions is spaced apart by a first distance in a first direction within the first fastening region,
wherein each of the second protrusions is spaced apart by the first distance in the first direction within the second fastening region,
wherein the first fastening region further includes third protrusions spaced apart from the first protrusions by a second distance in a second direction perpendicular to the first direction, and
wherein the second fastening region further includes fourth protrusions spaced apart from the second protrusions by the second distance in a third direction opposite to the second direction.

19. The case of claim 16,
wherein the frame further includes a third periphery connecting the first periphery and the second periphery, a fourth periphery facing away from the third periphery, and a first fastening structure comprising a groove formed along the third periphery, and a second fastening structure comprising a groove formed along the fourth periphery,
wherein the cover plate further includes a third fastening structure comprising a groove, fastened to the first fastening structure, formed at a periphery extending in a direction parallel to the third periphery; and a fourth fastening structure comprising a groove, fastened to the second fastening structure, formed at another periphery facing away from the periphery of the cover plate.

20. The case of claim 19,
wherein the first fastening structure includes a first flange extending from the third periphery towards the second surface of the cover plate fastened to the frame,
wherein the second fastening structure includes a second flange extending from the fourth periphery towards the second surface of the cover plate,
wherein the third fastening structure includes a third groove where the first flange portion is inserted, and
wherein the fourth fastening structure includes a fourth groove where the second flange portion is inserted.
